(19) United States
(12) Patent Application Publication
(10) Pub. No.: US 2022/0169084 A1
(43) Pub. Date: Jun. 2, 2022

(54) SYSTEM FOR INFLATING A TIRE OF A WHEEL, CONFIGURED TO BE BUILD INSIDE OR ONTO A HUB OF A VEHICLE

(71) Applicant: HUBTECH HOLDING B.V., EINDHOVEN (NL)

(72) Inventors: Gertjan VAN GINDEREN, Eindhoven (NL); Eugéne Antoine Adriaan HERBEN, EINDHOVEN (NL)

(21) Appl. No.: 17/601,268

(22) PCT Filed: Apr. 3, 2020
(86) PCT No.: PCT/EP2020/059571

§ 371 Date: Oct. 4, 2021

(30) Foreign Application Priority Data
Apr. 5, 2019 (NL) 2022873

(51) Int. Cl. B60C 23/12; B60C 23/00

(52) U.S. Cl. CPC B60C 23/127; B60C 23/004

(57) ABSTRACT

System for inflating a tire of a wheel, configured to be build inside or onto a hub of a vehicle, comprising a stationary section and a rotary section wherein the stationary section comprises a first clutch part, wherein the rotary section comprises a second clutch part, configured to selectively engage the first clutch part; an actuator, a driving unit, a pumping unit, and a housing, for housing at least the pumping unit, wherein the housing and the pumping unit are arranged to move together with movement of a wheel, in particular rotate together with the wheel.

The present invention relates to a system for inflating a tire of a wheel, configured to be build inside or onto a hub of a vehicle, as well as to a wheel hub or vehicle provided with such system.

For safety sake, vehicles may be provided with tire pressure systems, that monitor the pressure inside tires and can be used to regulate that pressure. Additionally, improved tire pressures have additional benefits, such as lower friction, reduced wear and possible increased grip on certain surfaces and increased comfort. Such system is for instance disclosed in EP 0 263 251, which relates to a system for detecting the air pressure in each wheel and for effecting inflation or deflation in each wheel while the vehicle is operating including a controller and a high pressure reservoir mounted on each wheel. Each controller includes a magnet that is positioned responsive to the pressure in the associated tire and a stationary mounted solenoid detector senses the position of the magnet and generates a signal which is fed to a data processor for the generation of an output signal to the vehicle operator indicating the pressure in the tire. Additionally, through actuation of the control, a current is passed through a coil on the solenoid detector to actuate the magnet in an individual wheel for opening a valve and allowing air to flow through the tube into the tire for raising the tire pressure, or to allow the exhaust of air to lower the tire pressure.

Although such system may be used, the amount of pressurized air is limited. It is therefore an objective of the present invention to provide an improved system for inflating a tire of a wheel, which overcomes the drawbacks of the prior art.

The invention therefore proposes a system according to claim 1. The system according to the invention is configured to be build inside or onto a hub of a vehicle. There components are already there, and the system does not need additional space or room inside or onto the vehicle.

A wheel hub, or hub, comprises a retaining plate for connecting the hub to a suspension of a vehicle, and a wheel mounting plate, for mounting a wheel to the hub. Typically, the wheel hub also comprises a brake disk or brake disk housing. Of these components, the retaining plate is a stationary part, which is fixed to the vehicle. The other components are typically rotating together with the wheel (upon rotation of the wheel). The present invention uses this mutual rotation of elements in the wheel hub for inflation of the tire.

Arranged around a central rotation axis of the wheel a driving unit is arranged, which comprises a cam shaft. Around this driving unit a pumping unit is arranged, which is driven by the driving unit, and in particular by the cam shaft thereof. In the present invention, the drive unit and the pumping unit can either co-rotate, or have a mutual rotation (such that they can rotate with respect to one another). When the drive unit and the pumping unit co-rotate, they both rotate at approximately the same speed, and no substantial pumping action is provided. This is due to the pump unit and the cam shaft moving together instead of with respect to one another. When there is a mutual rotation, for instance when one of the components is fixed and one rotates, the mutual rotation provides a drive of the pumping unit, and the driven pumping unit can pump. The selection of either drive, or not drive, the pumping unit in the invention is provided by a clutch.

By providing the system in the hub of the vehicle, it is possible to provide each wheel (or each wheel hub) with its own system, wherein each system can be integrated in the existing space in such wheel or wheel hubs, thus providing an efficient system. The system does not require to run electric, pneumatic or hydraulic wiring between the different wheels of a vehicle, or a central air pressure system for managing the tire pressures.

The system may be configured to be arranged between a retaining plate and a wheel mounting plate of a wheel hub. The system can thus be arranged between existing hub parts, and can thus be provided as an aftermarket kit, or it can be used to outfit new hubs and vehicles with such system. In wheel hubs, a space typically exists between the two parts, which allows for the provision of the system, without requiring additional space.

The first and second clutch parts may be annular clutch parts, configured to be arranged around the hub of the vehicle. With annular is meant that they both comprise a central opening or recess, through which opening or recess typically the rotating components of the hub may extend. These rotating components also comprise the central rotation axis of the wheel, which thus typically also extends through the opening or recess of the clutch parts.

The rotary section may comprise a biasing element, such as a spring, to bias the second clutch part in the engaged position, wherein the actuator may be configured to actuate against the biasing force exerted by the biasing element. By forcing the clutch parts in the engaged position, the default mode of the system is to provide pressurized air to the tire. The advantage of such system is that the actuator may be pneumatically operated, under influence of the tire pressure itself. If the tire pressure is high, or sufficiently high such that no pumping action is required, the air pressure in the tire can be used to operate the actuator, and put the clutch in the non-engaging position. When tire pressure drops, for instance due to a puncture, the tire pressure may automatically be too low to provide the actuator with sufficient force, which automatically results in the engagement of the clutch and the pumping of air into the tire, in turn inflating the tire. An automatic tire pressure system can thus be provided, wherein the pressure in the tire can be set or changed under influence of changing the biasing force exerted by the biasing element. As an example, when tire pressure changes, and drops below a certain predetermined tire pressure, say 1 bar, the clutch will automatically be engaged and activate the pump unit to increase pressure. The engagement of the clutch and activation of the pump unit may also be used to power an electronic control unit. This unit is preferably powered by the same drive as the pump unit, which would allow electronic management of the system once the clutch is engaged.

A bearing may be provided between the drive means and the pump unit, to allow mutual rotation between the drive means and the pump unit. A bearing between the drive means the pump unit allows the drive means and the pump unit to mutually rotate without much friction, and thus relatively efficiently. The bearing may for instance comprise an inner ring, attached to the drive means, an outer ring attached to the pump unit and multiple bearing balls arranged between the two rings.

The pump elements may comprise a filter, for filtering the air to prevent clogging, wherein preferably the pump elements comprise air inlets, for taking in ambient air, wherein the filters are preferably provided in the air inlets. The pump elements are used to pump ambient air, at ambient air pressure, and deliver pressurized air. To avoid dirt, debris or other particles in the outside air to clog or contaminate the pump elements, filters may be used. The air inlets of the pump elements may also be used to expel excess pressurized air from the system as well, wherein expelling pressurized air through the inlet and thus through the filters could thus clean any debris on the filters as well.

The pump elements may be configured to make a reciprocal movement upon rotation of the cam shaft, in particular one perpendicular to the axis of rotation of the cam shaft. The pump unit comprises, for example, at least two pistons or bellows for compressing air, in which each piston or bellows is provided, for example, with a non-return valve, which valve allows air to be supplied, but prevents compressed air from leaking. The pump unit is, for example, a displacement pump. In this case, the pistons or bellows are configured for admitting pressure at a first pressure, for example atmospheric pressure, via a line or opening with a non-return valve. This prevents air which is compressed in the pump unit from escaping to the outside air again. The bellows are, for example, (glass fibre-)reinforced bellows, so that they withstand increased pressures, in particular in a second or subsequent step. The reinforcement of the bellows comprises, for example, rubber, glass fibre, silk, Nomex, Dyneema or Kevlar. Alternatively, membranes or diaphragms can be used to compress the air, which membranes of diaphragms are possibly provided with an air inlet valve (or inlet check valve) and an air outlet valve (or outlet check valve). Also other compression mechanisms may be applied for pumping the air upon pumping movement of the pump unit.

The pump unit may also comprise, for example, several cylinders which are rigidly connected to the pump unit and several pistons which are configured to move in the cylinders in a radial direction with respect to the rotation axis or the drive unit. The pistons move in a reciprocating manner in the cylinders, for example on account of the rotation of the drive unit. The cylinders are distributed, for example, proportionally at equal distance from each other along a(-n imaginary) circumference of the hub or equidistant around the drive unit. The cylinders may also be distributed over several shells, in which each shell comprises at least two cylinders distributed at equal distances from each other over the circumference of the pump unit, in which the shells are situated substantially parallel to each other. Each shell extends substantially in the radial direction at a different position of the drive unit. In this way, several cylinders and pistons in the same pump unit can be driven by the same drive, in which the drive of each shell can be adjusted with respect to other shells, for example by a camshaft on the drive unit. Each piston is provided, for example, with a cam follower and the drive is provided, for example, with a cam system to which the cam followers are coupled. During rotation, the cams of the cam system execute, for example, an eccentric circle with respect to the rotation axle and thus the piston connected to the cam follower executes a translational, reciprocating, movement inside the cylinder.

The pump unit may comprise multiple pumping elements, preferably interconnected pumping elements, arranged radially around the driving unit, and/or the pump elements may be configured to pump surrounding air upon mutual rotation of the pump unit and the pump drive means.

At least two, and preferably all, pumping elements may be arranged in parallel. This way the pumping elements provide the largest volume of compressed air, as each of the pumping elements acts or pumps individually.

Alternatively, at least two pump elements may be arranged in series, such that at least a two-stage pumping action can be achieved, to increase the maximum air pressure provided by the pumping unit. The pump unit may then comprise an air reservoir, to store air at increased pressure. The pump unit may then be configured, for example, to compress air in at least two separate steps, in which the pump unit is configured, for example, to compress air to a pressure in the air reservoir of up to 3.5 bar in a first step, and to compress the compressed air further in a subsequent second step to a pressure of up to 11 bar. Compressing the air in several steps causes less loss of energy in these steps. The pump unit may be configured, for example, to compress air in at least two separate steps, in a first step to 1.5 to 4 times atmospheric pressure and in a second step up to 3 times the first pressure. Such pressure may for instance be used in truck tires, where a high pressure is required.

Pumping, or compressing, the air usually proceeds isentropically, without an exchange of energy with the surroundings, and compression proceeds quickly. Such a compression results in heating of the air and subsequent compression thus requires more work. The increase in work associated with compression depends on the ratio between the starting volume and the final volume of the compression stroke, and also on a coefficient, according to the following formula:

1−(V₁/V₂)^{k-1}

In this formula, V1 is the starting volume of the compression and V2 the final volume of the compression. With an isentropic compression, the coefficient k equals 1.4, and with a (slower) isothermic compression it equals 1.0. Thus, there is no increase in work in the case of an isothermic compression. Since the increase in work thus depends on the relative (starting and final) volumes, it is advantageous to limit the difference (ratio) of these volumes per compression stroke.

The system may comprise a pressure management system, for managing the pressure inside a tire of a wheel connected to the wheel hub. The pressure management may for instance be arranged to control the actuator of the system, which in turn operates the clutch of the system. The pressure management system may for instance be a pneumatic management system, which allows the pressure management system to use air pressure in vehicle wheel tires for instance to operate. Preferably, the pressure management system is configured to allow air to be provided to the tire, as well as to allow air to leave the tire, to allow management of the pressure in both directions (up and down).

The stationary section may comprise an power supply, connectable to a (main) battery of the vehicle, for the powering pressure management system, wherein the power supply is preferably arranged for wireless power transfer, for instance via inductive antennas. Since the power supply is provided on the stationary section, and thus does not rotate with the wheel, a relative simple connection to a (main) battery of the vehicle can be provided. To transfer the power from the stationary section to the rotary section, wireless power transfer is preferred, as this would not require elaborate rotation couplings between the two sections. Such wireless transfer may be provided by inductive ring antennas. One ring may be provided on the stationary section, and one ring may be provided on the rotary section, wherein a gap is present between the two rings to allow mutual rotation of the two rings. The gap should be sufficiently small to still allow wireless, or inductive, power transfer.

The wireless power transfer system may also be used to communicate data, for instance via near field technology (NFC) or RFID. For instance, a pressure sensor may be provided on the rotary section of the system. Through NFC or RFID, the information on the pressure may be transmitted to the stationary section, wherein this information could in turn be communicated to for instance an on-board computer unit of a vehicle.

The power, provided by the power supply, may be used by the pressure management system. The pressure management system may comprise at least one valve, preferable multiple valves, which valves are preferably controllable by the pressure management system and/or can be powered by the power supply. Powering the power supply typically results in the valves being opened or closed. The system may also be provided with power storage modules, such as power caps, batteries or capacitors. These storage modules are preferably configured to store at least sufficient energy to power the valves of the clutch system.

The pressure management system may be provided with a pressure sensor (38), for measuring the pressure inside a tire, which sensor may thus be connected to the tire. When the pressure inside the tire is above a threshold value for instance, no (more) pumping is required. Then, a first valve may be operated, and typically opened. This valve allows pressurized or pumped air to go to the actuator, which in turn operates the clutch parts to a disengaged position, wherein no air is pumped by the pump unit. To prevent air from passing from the tire to the pump unit in this setting, a non-return valve is provided between the pump unit and the tire. A second valve may be provided, which when opened allows air, which passed through the first valve, to pass to the ambient. Passing air from the tire to the ambient thus requires opening of the two valves.

The system may be provided with an air inlet, for taking in ambient air, which air inlet may be provided with an air filter. Via the inlet, ambient air may be provided to the pump unit, which provided pressurized or pumped air to an air outlet of the system. This air outlet may be connected to a tire.

The system may also be provided with an air storage, for storing air at increased pressure. The size of the air store is typically determined by the available space between the stationary and the rotary hub parts. The storage is typically provided between the pump unit and the tire.

The present invention also relates to a wheel hub, a wheel and a vehicle, provided with a system according to the invention. The wheel is typically provided with a (inflatable) tire, wherein the air inlet of the tire is connected, for instance by tubing, to the air outlet of the system, to allow pressurized or pumped air to be provided to the tire. The same tubing may allow air to be passed from the tire to the ambient or to the actuator of the system.

The invention will be explained by means of the non-limiting exemplary embodiments which are illustrated in the following figures, in which:

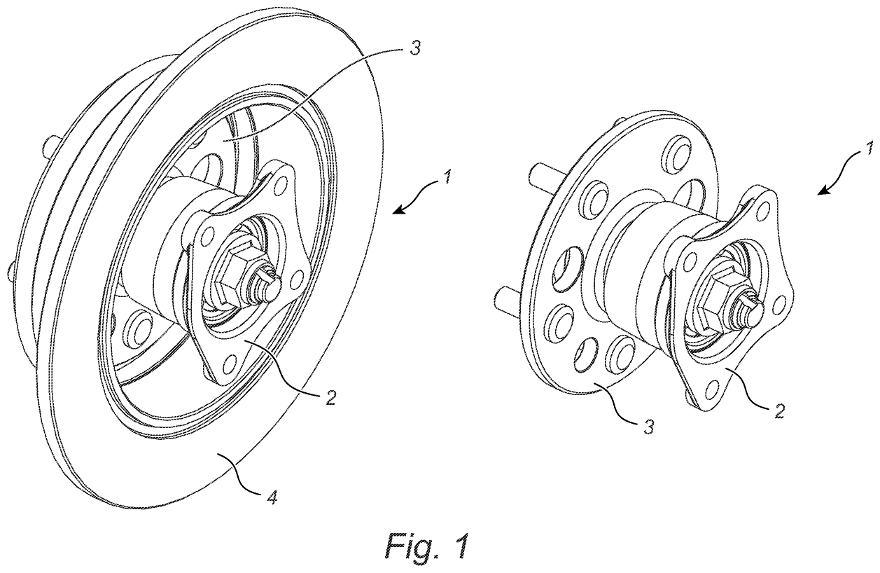

FIG. 1 schematically shows a wheel hub according to the invention;

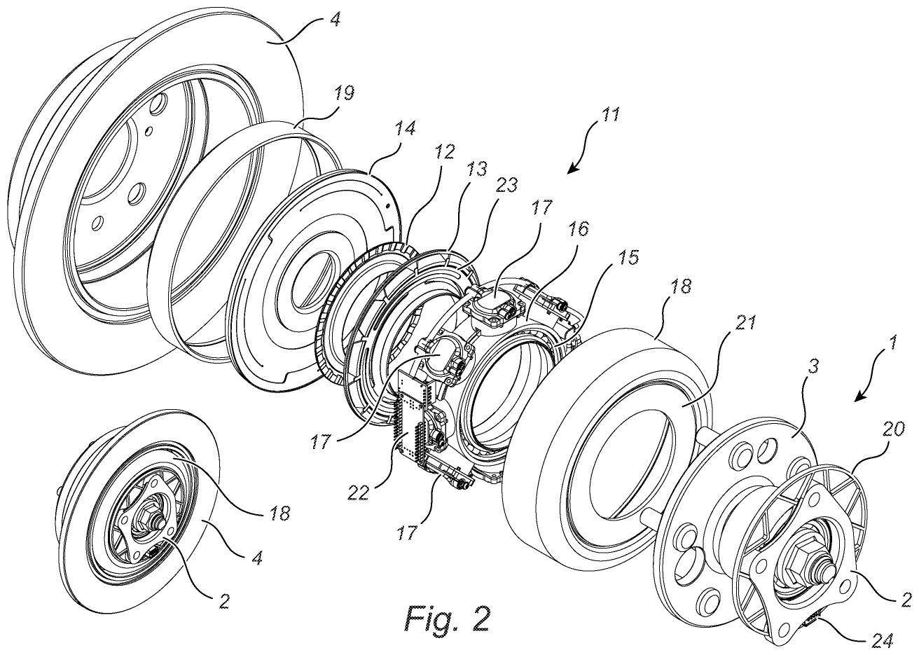

FIG. 2 schematically shows a system according to the invention in an exploded view;

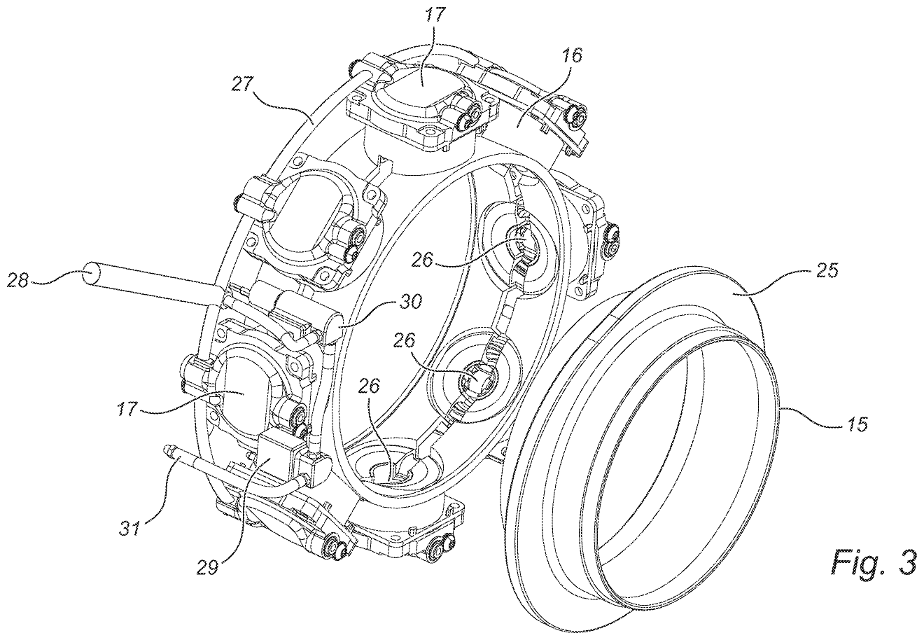

FIG. 3 shows a detail of the pump unit and the drive unit according to the invention in an exploded view;

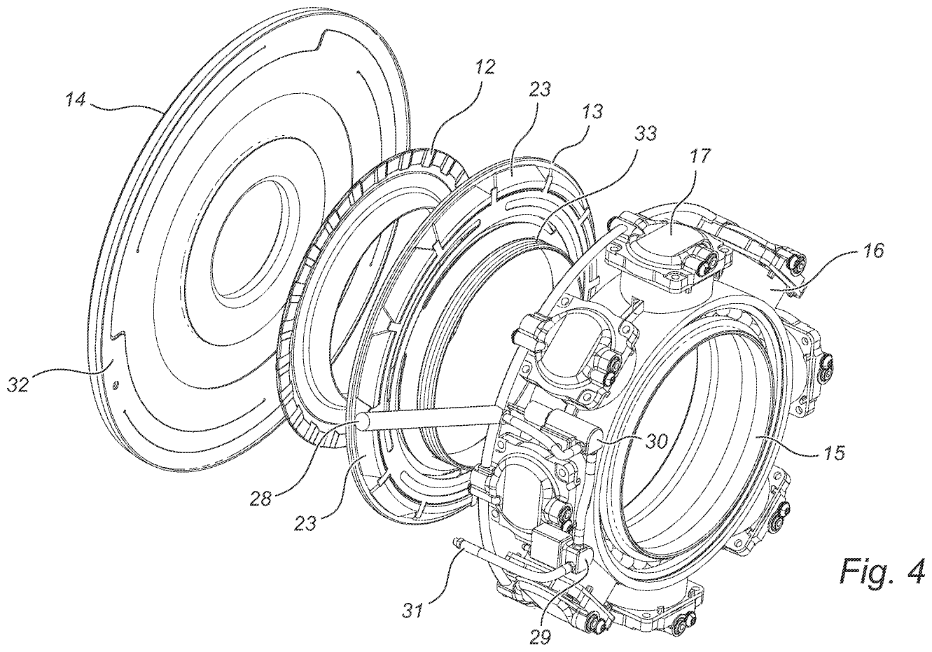

FIG. 4 shows a detail including the first and second clutch plates, the biasing element and the actuator according to the invention;

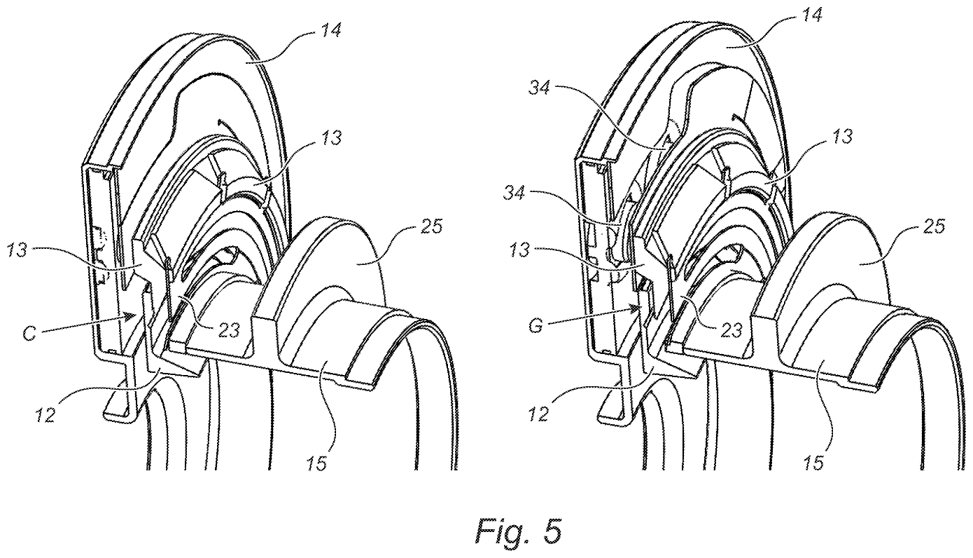

FIG. 5 schematically shows operation of the clutch according to the invention;

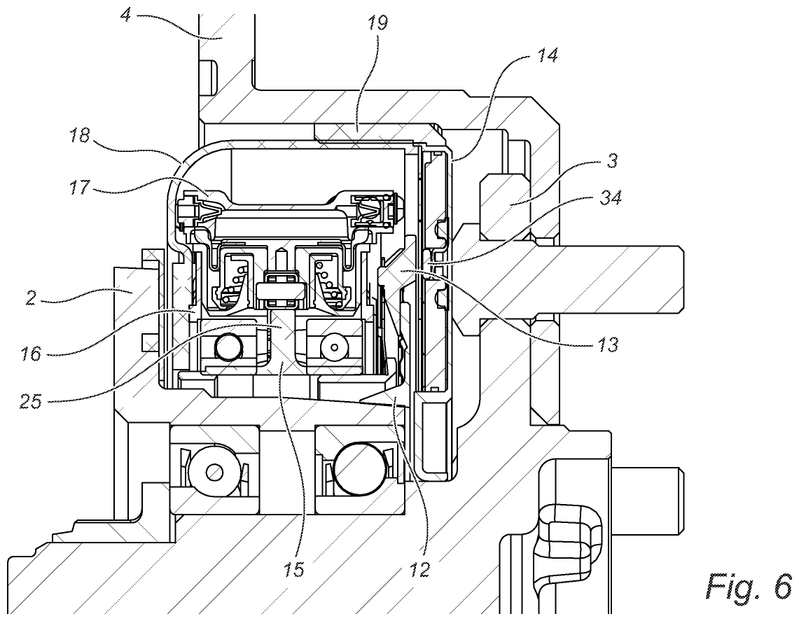

FIG. 6 schematically shows a part of a cross section of a wheel hub with a system according to the invention

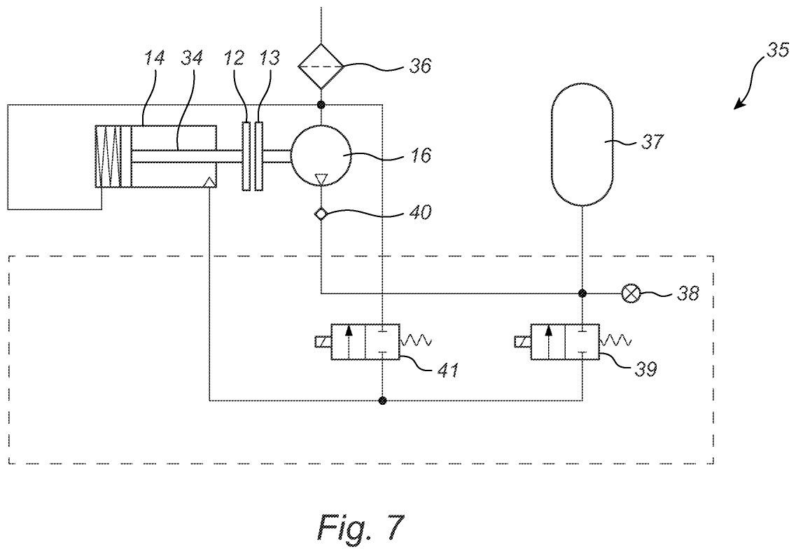

FIG. 7 schematically shows a pressure management system according to the invention.

FIG. 1 schematically shows a wheel hub (1), according to the prior art. The wheel hub (1) comprises a retaining plate (2), for connecting the hub (1) to a suspension of a vehicle, and a wheel mounting plate (3), for mounting a wheel to the hub (1). On the left, the wheel hub (1) if also provided with a brake disk (4) or brake disk housing (4). Of these components, the retaining plate (2) is a stationary part, which is fixed to the vehicle. The other components are typically rotating together with the wheel (upon rotation of the wheel).

On the left in FIG. 1, a donut-shaped area can be observed, arranged between the wheel mounting plate (3) and the retaining plate (2) of the hub (1). In this area, the system according to the invention can be provided.

FIG. 2 schematically shows a system (11) according to the invention, as well as the wheel hub (1) as shown in FIG. 1, in an exploded view, as well as an unexploded view on the bottom left. The system (11) is arranged to be provided within the boundaries of the hub (1), and could thus be fitted onto existing hubs (1). The system (11) comprises a first clutch part (12), which is part of the stationary section (12). The system (11) further comprises a second clutch part (13), an actuator (14), a driving unit (15), a pumping unit (16) with pumping elements (17) and a housing (18), which elements are part of the rotary section when the clutch parts (12, 13) are not engaged. FIG. 2 further shows an optional attachment ring (19), for attaching the rotary section to the brake disk (4), as well as optional inductive power antennas (20, 21) and optional electronic systems (22). The second clutch part (13) is in FIG. 2 also provided with a biasing element (23), and the inductive power antenna (20) is provide with an optional power socket (24).

FIG. 3 shows a detail of the pump unit (16) and the drive unit (15), in an exploded view. The drive unit (15) is provided with a cam shaft (25), which is not circular (that is, it is substantially oval shaped or ellipsoidal). The pumping elements (17) are each provided with a cam follower (26), such that upon rotation of the cam shaft (25), this rotation is translated in reciprocal movement by the cam followers (26) of the pumping elements (17). Air is pumped by the pumping elements (17), into a collecting ring (27), which is coupled to a tire connection (28) for connecting the ring (27) to an inflatable tire. FIG. 3 further shows two valves (29, 30), and an actuator connection (31), for connecting the actuator (14) to pressurized air, as will be explained in FIG. 4.

FIG. 4 shows a similar detail as FIG. 3, including the first and second clutch plates (12, 13), the biasing element (23) and the actuator (14). The biasing element (23) forces the second clutch plate (13) against the first clutch plate (12). The actuator connection (31) can be connected to a coupling (32) of the actuator, which actuator is a pneumatic actuator (14). Upon control of the valves (29, 30), pressurized air can be provided to the actuator (14), via the connection (31) and the coupling (32). The outer parts of the actuator (14), corresponding with the outer parts of the second clutch part (13), can expand when provided with an increased air pressure. This increase in pressure, and expansion of the actuator (14), results in movement of the second clutch plate (13), away from the first clutch plate (12), and thus results in disengaging the clutch. FIG. 4 also schematically shows an attachment element (33), attaching the second clutch part (13) to the drive unit (15).

FIG. 5 schematically shows the actuator (14), provided with two pneumatic elements (34). On the left, the elements (34) are unextended, and unpressurized. On the right, the elements (34) are extended and pressurized. On the left, an engaged position is shown, in which the two clutch plates (12, 13) are coupled. On the right, an un-engaged position is shown, in which the two clutch plates (12, 13) are distanced and uncoupled. The uncoupled state shows a gap (G) between the plates (12, 13), which is not present in the coupled state (C). Other elements have been given the same reference numerals as used in the previous figures.

FIG. 6 schematically shows a part of a cross section of a wheel hub (1) with a system (11) according to the invention, in unexploded view. In FIG. 6, the first and second clutch plates (12, 13) are shown in an engaged position. The hub in FIG. 6 again has a stationary retaining plate (2), for connecting the hub (1) to a suspension of a vehicle, and a wheel mounting plate (3), for mounting a wheel to the hub (1), and the wheel hub (1) is also provided with a brake disk (4) or brake disk housing (4).

The first clutch plate (12) is connected to the retaining plate (2), and is thus stationary. The second clutch plate (13) is engaged to the first clutch plate (12), and thus also stationary. Attached to the second clutch plate (13) is the drive unit (15) with cam (25). In the engaged position, this drive unit (15) is thus also stationary.

Between the second clutch plate (13) and the actuator (14) a gap is present, such that the actuator is part of the rotary section. The housing (18), pump unit (16) with pump elements (17) is part of the rotary section, and rotates together with the wheel, wheel hub and brake disk (4).

Upon rotation, the rotary section, with the pump unit (16) thus rotates with respect to the drive unit (15). The cam followers (26) of the pump elements (17) thus encounter the cams (25) of the drive unit (15), resulting in the pumping action of the system in the engaged position.

To unengaged, the actuator unit (14) activates, causing the pneumatic element (34) to expand and engage the second clutch plate (13). This in turn uncoupled the plates (12, 13) and makes the second clutch part (13) part of the rotary section. In the non-engaged position, the drive unit (15), attached to the rotating second clutch part (13) thus rotates together with the pump unit (16). Due to the lack of mutual movement of the pump unit (16) and the drive unit (15), no pumping action occurs.

FIG. 7 schematically shows a pressure management system (35) according to the invention. Shown in FIG. 7 are also the first (12) and second (13) clutch parts, the actuator (14) and the pump unit (16), as shown for instance in the preceding figures. The pump unit (16) connects to the ambient air through an air filter (36). Ambient air is pressurized, or pumped, by the pump unit (16) into a tire (37). The pressure management system (35) is further provided with a pressure sensor (38), for measuring the pressure inside the tire (37), which sensor (38) is thus connected to the tire (37). When the pressure inside the tire (37) is above a threshold value for instance, no more pumping is required. Then, a first valve (39) is operated, an typically opened. This valve (39) allows pressurized or pumped air to go to the actuator (14), which in turn operates the clutch parts (12, 13) to a disengaged position, wherein no air is pumped by the pump unit (16). To prevent air from passing from the tire to the pump unit (16) in this setting, a non-return valve (40) is provided. A second valve (41) is provided, which when opened allows air, which passed through the first valve (39), to pass to the ambient. Passing air from the tire (37) to the ambient thus requires opening of the two valves (39, 41).

Although the figures show a rotary section with an axis mounted in a stationary hub part or tube, the invention may also be applied to a hub which provided a rotary hub part mounted about a stationary axis or tube.

1-16. (canceled)

17. A system for inflating a tire of a wheel, configured to be built inside or onto a wheel hub of a vehicle, comprising:
a stationary section configured to be connected to a stationary part of the wheel hub; and
a rotary section configured to be connected to a wheel mounting part of the wheel hub;
wherein the stationary section comprises:
a first clutch part configured to be attached to the stationary part of the wheel hub;
wherein the rotary section comprises:
a second clutch part configured to selectively engage the first clutch part;
an actuator configured to move the second clutch part between an engaging position and a non-engaging position;
a driving unit connected to the second clutch part and including a cam shaft;
a pumping unit positioned radially around the driving unit and including at least one pump element configured to be driven by the cam shaft of the driving unit and pump ambient air, wherein the pumping unit is configured to be attached to an inflatable tire of the wheel, to provide air to the tire; and
a housing, for housing at least the pumping unit, wherein the housing and the pumping unit are configured to rotate together with movement of the wheel;
wherein, in the non-engaging position, the first and second clutch parts are positioned at a distance, and are mutually rotatable, and wherein in the engaging position the first and second clutch parts are connected and are co-rotatable; and
wherein, in the engaging position, the second clutch part and the driving unit are connected to the stationary section such that upon rotation the driving unit rotates with respect to the pumping unit.

18. The system according to claim 17, wherein the stationary part is a retaining plate and the wheel mounting part is a brake disk housing or wheel mounting plate.

19. The system according to claim 18, wherein the system is configured to be positioned between the retaining plate and the wheel mounting plate.

20. The system according to claim 17, wherein the first and second clutch parts are annular clutch parts configured to be positioned around the wheel hub.

21. The system according to claim 17, wherein the rotary section comprises a biasing element configured to bias the second clutch part toward the engaging position, and wherein the actuator is configured to actuate against the biasing force exerted by the biasing element.

22. The system according to claim 21, wherein the biasing element is a spring.

23. The system according to claim 17, further comprising a bearing positioned between the driving unit and the pumping unit configured to allow mutual rotation between the driving unit and the pumping unit.

24. The system according to claim 17, wherein the at least one pump element comprises a plurality of air inlets for intaking ambient air and a filter positioned in each of the plurality of air inlets configured to filter the ambient air.

25. The system according to claim 17, wherein the at least one pump element is configured to make a reciprocal movement upon rotation of the cam shaft, the reciprocal movement perpendicular to an axis of rotation of the cam shaft.

26. The system according to claim 17, wherein the pumping unit comprises a plurality of interconnected pumping elements positioned radially around the driving unit configured to pump surrounding air upon mutual rotation of the pumping unit and the driving unit.

27. The system according to claim 26, wherein at least two of the plurality of interconnected pumping element are positioned in parallel.

28. The system according to claim 26, wherein at least two of the plurality of interconnected pumping elements are positioned in series to provide at least a two-stage pumping action to increase air pressure provided by the pumping unit.

29. The system according to claim 17, further comprising a pressure management system configured to manage the pressure inside a tire of a wheel connected to the wheel hub.

30. The system according to claim 29, wherein the stationary section comprises a power supply, connectable to a vehicle battery, configured to power the pressure management system.

31. The system according to claim 30, wherein the power supply comprises at least one inductive antenna configured for wireless power transfer.

32. The system according to claim 30, wherein the pressure management system comprises a plurality of valves configured to be controlled by the pressure management system and powered by the power supply.

33. An assembly, comprising:
a wheel hub including the system according to claim 17;
a wheel; and
an inflatable tire.

34. The assembly according to claim 33, wherein the inflatable tire and the pumping unit are connected.

35. A vehicle comprising the assembly according to claim 33.
